(19) United States
(12) Patent Application Publication
(10) Pub. No.: US 2021/0218793 A1
(43) Pub. Date: Jul. 15, 2021

(54) INFORMATION PROCESSING APPARATUS, INFORMATION PROCESSING METHOD, PROGRAM, AND IOT DEVICE

(71) Applicant: SONY CORPORATION, TOKYO (JP)

(72) Inventors: TAKASHI ABE, TOKYO (JP); TAKUMI YAJIMA, TOKYO (JP)

(21) Appl. No.: 17/056,273

(22) PCT Filed: May 29, 2019
(86) PCT No.: PCT/JP2019/021207

§ 371 Date: Nov. 17, 2020

(30) Foreign Application Priority Data
Jun. 6, 2018 (JP) 2018-108810

(51) Int. Cl. H04L 29/08; G06N 3/08

(52) U.S. Cl. CPC H04L 67/06; G06N 3/08; H04L 67/025; H04L 67/32

(57) ABSTRACT

To improve performance of an IoT system while taking into account differences and fluctuations in performance of IoT devices. There is provided an information processing apparatus including: a communication unit capable of communicating with an IoT (Internet of Things) device; and a control unit. The control unit optimizes a trained neural network on the basis of IoT device provision information regarding a state of the IoT device or a surrounding environment, the IoT device provision information being received from the IoT device, and transmits an execution file of the trained neural network after the optimization to the IoT device.

### TECHNICAL FIELD

The present technology relates to an information processing apparatus, an information processing method, a program, and an IoT device, and relates to a technology for improving the performance as the whole IoT system.

### BACKGROUND ART

Patent Literature 1 discloses a technology for optimizing the size of a downloaded program in the technological field of a small information apparatus. In order to achieve the object, Patent Literature 1 shows that unnecessary modules are separated on the basis of user profile data input by a user.

### CITATION LIST

### Patent Literature

Patent Literature 1: Japanese Patent Application Laid-open No. 2003-216434

### DISCLOSURE OF INVENTION

### Technical Problem

In a network called “Internet of Things” (IoT) (hereinafter, referred to as the “IoT system”), it is envisioned that everything is connected as end devices (hereinafter, referred to as “IoT devices”). In this case, there is a possibility that devices with poor performance due to limitations such as physical sizing, such as arithmetic devices and memories, are also connected to the IoT. Further, the performance of the devices is not fixed, and varies due to factors such as the remaining battery level and temperature.

The background technology does not fully achieve the object of optimizing the program executed by the IoT device in response to differences and fluctuations in performance of the respective IoT devices. In the technology disclosed in Patent Literature 1, since a normal source code is targeted for optimization, only the size reduction is performed. Also, because user input is a trigger, optimization is not performed as long as there is no user operation.

In view of the circumstances as described above, it is an object of the present technology to provide an information processing apparatus, an information processing method, a program, and an IoT device that improve the performance of an IoT system taking into account differences and fluctuations in performance of IoT devices.

### Solution to Problem

An embodiment of the present technology for achieving the above-mentioned object is an information processing apparatus including: a communication unit capable of communicating with an IoT (Internet of Things) device; and a control unit.

The control unit optimizes a trained neural network on the basis of IoT device provision information regarding a state of the IoT device or a surrounding environment, the IoT device provision information being received from the IoT device, and transmits an execution file of the trained neural network after the optimization to the IoT device.

In accordance with an embodiment of the present technology, in an information processing apparatus in an IoT system, optimization of a trained neural network based on IoT device provision information regarding a state of an IoT device and/or a surrounding environment is performed, the IoT device provision information being received from the IoT device. Therefore, the performance of an IoT system can be improved taking into account the differences and variations in the performance of IoT devices.

In the information processing apparatus, the control unit may select, on the basis of a correspondence between the IoT device provision information and a plurality of trained neural networks after the optimization, the trained neural network corresponding to the IoT device provision information received from the IoT device.

In accordance with the information processing apparatus, since a trained neural network after the optimization is selected on the basis of a predetermined correspondence, efficient optimization can be achieved.

In the information processing apparatus, the IoT device provision information may include information based on an output obtained by inputting the state of the IoT device and/or the surrounding environment into the trained neural network installed in the IoT device, and the control unit may select one of the plurality of trained neural networks after the optimization on the basis of the information based on the output.

In accordance with the information processing apparatus, since the trained neural network is optimized on the basis of an output of the trained neural network, the performance of the IoT device can be brought more and the performance of the IoT system as a whole can be improved.

In the information processing apparatus, the IoT device provision information may include information specifying one of the pluralities of trained neural networks after the optimization, and the communication unit may transmit the specified trained neural network after the optimization.

In accordance with the information processing apparatus, since the communication from the IoT device to the information processing can be performed only by specifying one of the existing trained neural networks after the optimization, the communication traffic can be reduced.

The information processing apparatus may further include a cache that stores the trained neural network optimized by the control unit.

In this case, the communication unit may transmit, where the same trained neural network after the optimization corresponding to pieces of IoT device provision information received from the plurality of different IoT devices is stored in the cache, the same trained neural network after the optimization stored in the cache to the plurality of different IoT devices.

In accordance with the information processing apparatus, since the optimization processing in the information processing apparatus does not need to be performed each time, the computational complexity can be reduced.

In the information processing apparatus, the control unit may optimize the trained neural network by reducing performance and/or accuracy of the trained neural network as a classifier.

In accordance with the information processing apparatus, since the computational complexity in the IoT device is reduced, it is possible to reduce the amount of power consumed by the IoT device and the amount of heat generated in the IoT device.

In the information processing apparatus, the trained neural network may extract a feature amount from input information regarding the state of the IoT device and/or the surrounding environment, and classify the input information into a plurality of types on the basis of the extracted feature amount, and the control unit may reduce the number of the plurality of types classified by the trained neural network, thereby reducing performance and/or accuracy of the classifier.

In accordance with the information processing apparatus, since the computational complexity in the IoT device can be reduced, it is possible to reduce the amount of power consumed by the IoT device and the amount of heat generated in the IoT device.

Another embodiment of the present technology for achieving the above-mentioned object is an information processing method including: optimizing a trained neural network on the basis of information regarding a state of an IoT (Internet of Things) device and/or a surrounding environment, the information being received from the IoT device; and transmitting the optimized trained neural network to the IoT device.

Another embodiment of the present technology for achieving the above-mentioned object is a program that causes a computer to execute the steps of: optimizing a trained neural network on the basis of information regarding a state of an IoT (Internet of Things) device and/or a surrounding environment, the information being received from the IoT device; and transmitting the optimized trained neural network to the IoT device.

Another embodiment of the present technology for achieving the above-mentioned object is an IoT (Internet of Things) device in which a trained neural network is installed.

The IoT device includes: a communication unit capable of communicating with an information processing apparatus; and a control unit.

The control unit selects a trained neural network corresponding to a state of the IoT device and/or a surrounding environment.

The control unit transmits a request signal to the information processing apparatus, the request signal requesting optimization of the selected trained neural network and transmission of an execution file of the neural network after the optimization.

The control unit updates the installed trained neural network using the received execution file of the trained neural network after the optimization.

### Advantageous Effects of Invention

As described above, in accordance with the present technology, performance of an IoT system can be improved by taking into account differences and fluctuations in performance of IoT devices.

Note that the effect described here is not necessarily limitative, and any of the effects described in the present disclosure may be provided.

### BRIEF DESCRIPTION OF DRAWINGS

FIG. 1 is a conceptual diagram of a network configuration of a system according to a first embodiment.

FIG. 2 shows a hardware configuration example of a conversion server 100 according to a first embodiment, and the like.

FIG. 3 is a hardware configuration example of an IoT device 200 according to the first embodiment.

FIG. 4 is a functional block diagram of a system according to the first embodiment.

FIG. 5 is a conceptual diagram for describing a DNN in the first embodiment.

FIG. 6 is a flowchart showing an exemplary procedure of information processing of DNN updating according to the first embodiment.

FIG. 7 is a flowchart showing an exemplary procedure of information processing of DNN updating according to a second embodiment.

FIG. 8 is a flowchart showing an exemplary procedure of information processing of DNN updating according to a third embodiment.

FIG. 9 is a diagram showing an example of a correspondence table in the third embodiment.

FIG. 10 is a diagram illustrating an optimized DNN in the third embodiment.

FIG. 11 is a diagram showing an example of DNNs classified into different types by performing different kinds of optimization on one DNN, which are used in the above-mentioned embodiment.

FIG. 12 is a flowchart showing an exemplary procedure of information processing of DNN updating according to a fourth embodiment.

### MODE(S) FOR CARRYING OUT THE INVENTION

Hereinafter, embodiments according to the present technology will be described with reference to the drawings.

### First embodiment

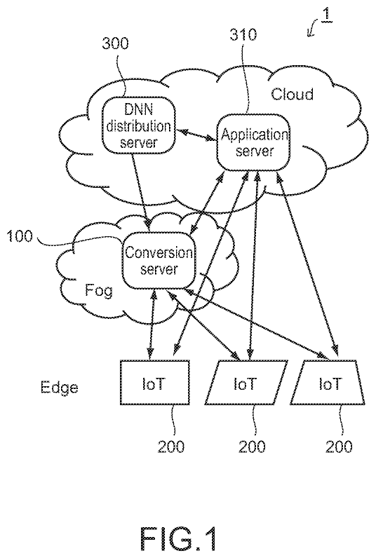

This embodiment discloses an example of an IoT system including a cloud and an edge. A trained neural network converted into an execution file format (hereinafter, referred to as “DNN”. DNN is an abbreviation for “Deep Neural Network”.) is installed in an IoT device 200 used as the edge-side device of such an IoT system 1 (FIG. 1).

The above-mentioned DNN functions as a classifier. The higher the recognition accuracy of such a DNN, the greater the computational complexity. Further, the power consumption also increases accordingly. However, the performance of the IoT device 200 differs among a plurality of devices. In addition, even in one IoT device 200, the performance is temporarily lowered or improved due to factors such as the remaining battery level. In addition, the performance that the IoT device 200 is capable exerting varies depending on the environments (e.g., temperature or humidity) in which the IoT device 200 is operating.

In the case where the recognition of the DNN is high in a situation where the IoT device 200 is capable of providing only low performance, the IoT device 200 does not operate with favorable performance and the performance of the IoT system 1 as a whole is lowered. Conversely, also in the case where the recognition accuracy of the DNN is low in a situation where the IoT device 200 is capable of providing high performance, the performance of the IoT system 1 as a whole is lowered. It is an object of this embodiment to optimize the DNN in accordance with the situation of the IoT device 200.

[System Configuration]

FIG. 1 is a conceptual diagram of a network configuration of a system (IoT system 1) according to this embodiment. The IoT system 1 is a cloud-edge type system including a group of server computers and a group of the IoT devices 200 that constitute a “cloud” and an “edge”, respectively. The IoT system 1 further includes a server layer called fog between the cloud and the edge. In the IoT system 1, the node closer to the cloud is upper and the node closer to the edge is lower.

The IoT system 1 includes, by way of example and not limitation, a DNN distribution server 300, an application server 310, a conversion server 100, and the IoT device 200. The DNN distribution server 300 and the application server 310 are located in the cloud. The conversion server 100 is located in the fog in this embodiment, but may also be located in the cloud.

As described above, in this embodiment, a DNN (Deep Neural Network) serving as an example of a trained neural network is configured to operate in the IoT device 200. However, since the IoT device cannot directly execute the DNN, the DNN needs to be converted into an execution file.

The IoT device 200 may download the converted execution file from the cloud and execute the downloaded file. Meanwhile, in this embodiment, the conversion server 100 located in the fog generates an optimized execution file for each the IoT devices 200.

At this time, for example, information such as the remaining battery level of each of the IoT devices 200 and temperature is transmitted from each of the IoT devices 200, the conversion server 100 changes the optimization policy in accordance with the circumstances. As a result, an execution file that is capable of bringing out the better performance the IoT device 200. Further, when the situation changes, the optimization is re-executed. As a result, the highest performance is maintained at all times.

In addition, since the IoT system 1 is capable of sharing one DNN with the plurality of conversion servers 100 under one DNN distribution server 300, costs can be reduced in the system as a whole.

In FIG. 1, the DNN distribution server 300 transmits a DNN file in response to a request from the conversion server 100. The application server 310 receives and records the outputs (including the recognition results of the DNN as a classifier and a recognition device) from the IoT device 200.

The conversion server 100 may be located on the cloud side and/or the fog side. In this embodiment, the conversion server 100 is located in the fog. The conversion server 100 converts the DNN file into a file that can be executed by the IoT device 200. Here, the conversion may be, but not limited to, information processing similar to the compilation of a program.

The IoT device 200 is, but not limited to, a monitoring camera in this embodiment. The IoT device 200 has a function of performing recognition processing on an image displayed on a camera 202 and transmitting the image to a server. The IoT device 200 also includes, but not limited to, various sensors 203 for grasping the state of the device itself and the surrounding state. Note that the camera 202 may be included in the sensor 203 for grasping the surrounding state.

[Hardware Configuration of Server and Device]

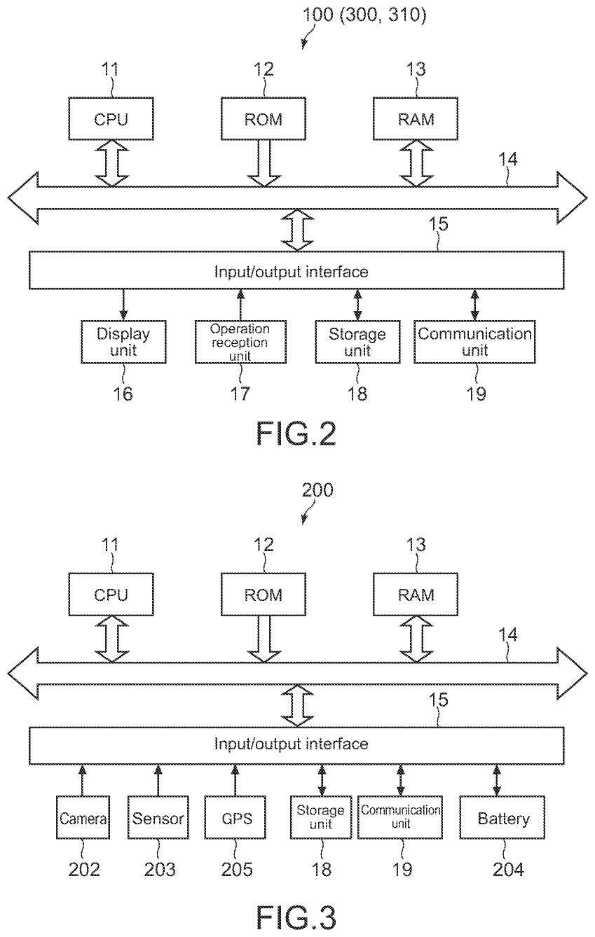

FIG. 2 is a block diagram showing a hardware configuration example of the conversion server 100 or the like. As shown in FIG. 2, the conversion server 100 has a configuration similar to that of a general-purpose computer. That is, the gateway 200 includes a CPU (Central Processing Unit) 11, a ROM (Read Only Memory) 12, a RAM (Random Access Memory) 13, an input/output interface 15, and a bus 14 that connects them to each other.

The CPU 11 appropriately accesses the RAM 13 or the like as necessary and integrally controls the entire blocks while performing various types of arithmetic processing. The ROM 12 is a non-volatile memory in which firmware such as an operating system (OS) to be executed by the CPU 11, a program, and various parameters is statically stored. The RAM 13 is used as a work area or the like of the CPU 11 and temporarily stores the OS, various applications being executed, and various types of data being processed.

Further, the CPU 11 configures a control unit of this device by loading a software program stored in the ROM 12.

A display unit 16, an operation reception unit 17, a storage unit 18, a communication unit 19, and the like are connected to the input/output interface 15. The display unit 16 is a display device using, for example, an LCD (Liquid Crystal Display), an OELD (Organic Electro-Luminescence Display), or a CRT (Cathode Ray Tube). The operation reception unit 17 is, for example, a pointing device such as a mouse, a keyboard, or another input device. Note that the display unit 16 and the operation reception unit 17 may be grouped together by a liquid crystal touch panel.

The storage unit 18 is a non-volatile memory such as an HDD (Hard Disk Drive), a flash memory (SSD; Solid State Drive), and another solid-state memory. The OS, various applications, and various types of data described above are stored in the storage unit 18.

The communication unit 19 is various modules for wireless communication such as a NIC (Network Interface Card) and a wireless LAN. The communication unit 19 enables the transmission and reception of data between this device and another device.

The configuration shown in FIG. 2 is an example, other elements may be added, and a part thereof may be omitted. The DNN distribution server 300 and the application server 310 can have configurations similar to that of the conversion server 100. Other elements may be added to the configurations of the DNN distribution server 300 and the application server 310, and a part thereof may be omitted.

FIG. 3 is a block diagram showing a hardware configuration example of the IoT device 200. In describing the respective units shown in FIG. 3, description of components common to those in FIG. 2 is omitted. The IoT device 200 shown in FIG. 3 includes the camera 202, the sensor 203, a battery 204, and a GPS 205.

The camera 202 is an imaging device such as a photoelectric conversion device. Specific examples of the sensor 203 include a thermal sensor, a human sensor, and an antenna capable of evaluating radio wave intensity and radio wave quality of wireless communication. However, the present example is not intended to limit the sensor100.

The battery 204 is a battery or the like for supplying power to the respective units of the IoT device 200. The battery 204 may have a function of detecting the remaining battery level of itself and notifying the CPU 11 or the like of it. The GPS 205 has a function of knowing the position of the device itself using a global positioning system. The GPS 205 may have a function of notifying the CPU 11 or the like of the detected position information.

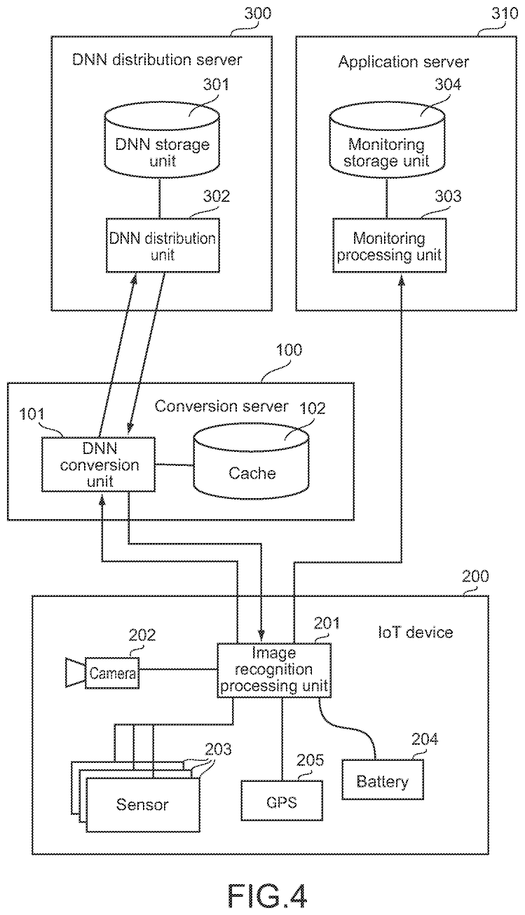

The information processing according to the present technology is realized by the software program installed in each server and each device using the hardware described above. From the aspect of the functional blocks that the respective servers and the respective devices have, each server and each device has functional blocks as shown in FIG. 4.

[Functional Configuration of System]

FIG. 4 is a functional block diagram of the IoT system 1 according to this embodiment. As shown in FIG. 4, the DNN distribution server 300 includes a DNN storage unit 301 and a DNN distribution unit 302. The DNN storage unit 301 saves and stores DNNs for processing images. In the DNN storage unit 301, a plurality of DNNs are prepared so that an optimal DNN can be selected depending on the state of the IoT device 200.

The DNN distribution unit 302 receives a request from the IoT device 200 and selects and transmits the optimal DNN from the DNN storage unit 301. In the case of receiving a DNN distribution request from the conversion server 100, the DNN distribution unit 302 transmits a DNN appropriate for the request to the conversion server 100.

The application server 310 includes a monitoring processing unit 303 and a monitoring storage unit 304. The monitoring storage unit 304 is a device for storing the recognition result transmitted from the IoT device 200. The monitoring processing unit 303 receives the recognition result transmitted from the IoT device 200. The monitoring processing unit 303 also has a monitoring function such as analyzing the recognition result and raising an alarm.

The conversion server 100 includes a DNN conversion unit 101 and a cache 102. The DNN conversion unit 101 converts a DNN file into an execution file. The DNN conversion unit 101 individually optimizes the DNN on the basis of IoT device provision information provided by the IoT device 200. The DNN conversion unit 101 transmits the DNN converted into an execution file to the IoT device 200.

The cache 102 primarily stores the DNN file received from the DNN distribution server 300 and the execution file optimized and/or converted by the DNN conversion unit 101.

The IoT device 200 includes an image recognition processing unit 201, the camera 202, the sensor 203, the battery 204, and the GPS 205. The blocks described with reference to FIG. 3 will not be described again. The image recognition processing unit 201 is a functional block for recognizing an object by processing an image taken by the camera 202. The image recognition processing unit 201 receives the DNN converted from into an execution file from the conversion server 100. The image recognition processing unit 201 uses the DNN received from the conversion server 100 when recognizing the image. The IoT device 200 installs (updates) the received DNN in the device itself and makes the CPU 11 also function as a recognizer and a classifier. The CPU 11 that functions as described above is the image recognition processing unit 201.

[Trained Neural Network]

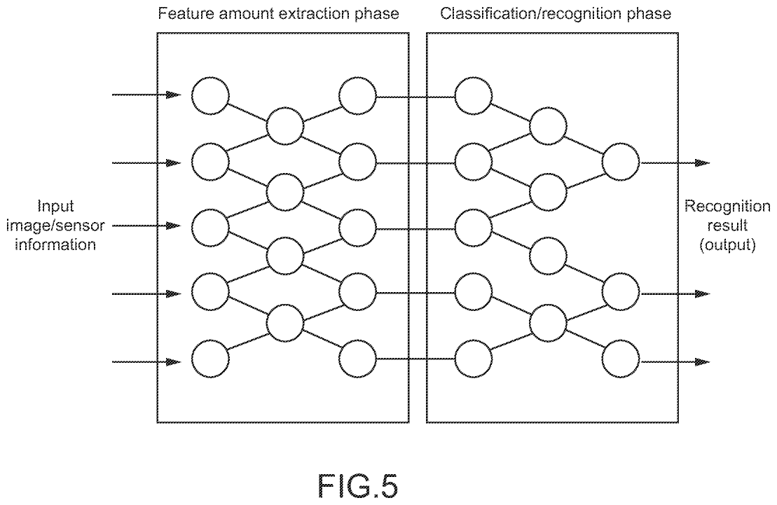

FIG. 5 is a conceptual diagram for describing a DNN (Deep Neural Network) in this embodiment. In FIG. 5, circles indicate virtual nodes generated in the IoT device 200, and solid lines connecting the virtual nodes indicate links. Each node knows, through deep learning, which node will be linked next when predetermined information (e.g., feature amount) is input from the left.

In this embodiment, image information obtained by imaging by the camera 202, information (e.g., air temperature or temperature of the device itself) sensed by the sensor 203, or the like is input to the DNN. In this case, the processing performed by the DNN is divided into a feature amount extraction phase and a classification/recognition phase.

In FIG. 5, a DNN in which image information or sensor information is input and any of three categorizable items is output is illustrated. For example, in the case of a DNN capable of identifying whether the subject in the image information is an animal, a plant, or an artificial object, there is a possibility that three kinds of outputs are obtained as shown in FIG. 5.

The IoT device 1 employs the system configuration as described above. Therefore, the IoT device 200 transmits the recognition result instead of transmitting the image as it is to the cloud, thereby reducing the communication traffic.

The IoT devices 200 may be dispersed in large quantities. In this case, since the conversion server 100 includes the cache 102, the communication traffic is reduced.

A plurality of the conversion server 100 may be provided. In this case, the conversion server 100 may be located for each region. Localization of the conversion server 100 in each region makes seasonal (northern hemisphere, southern hemisphere, and east-west and north-south of national land), temporal (day and night on the earth), and town and country (urban and suburban) differences the same among the IoT device 200. In this case, the caches 102 of the same condition are easily collected, which obtains higher efficiency.

Note that if the number of the IoT devices 200 is sufficiently small in the above-mentioned configuration of the IoT system 1, the server group in the cloud and the conversion server 100 may be the same machine. However, if the number of the IoT devices 200 is too large, the communication traffic is expected to be reduced by disposing the conversion server 100 for each region. In the case where the number of the IoT devices 200 is too large, the DNN distribution server 300 and the application server 310 may be different machines as shown in FIG. 1 and FIG. 4. Such different machines allow load-balancing. Note that in the case where the DNNs stored in the DNN storage unit 301 are the same, a plurality of the DNN distribution unit 302 may be used for load-balancing.

[Information Processing]

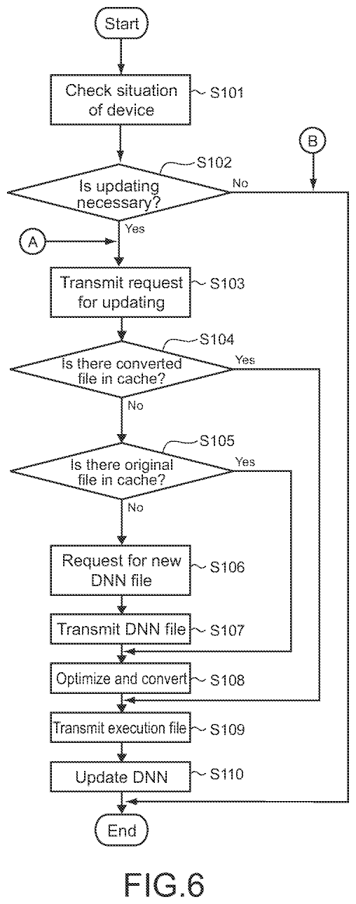

Next, information processing relating to DNN distribution and DNN updating in the IoT system 1 will be described below. FIG. 6 is a flowchart illustrating an exemplary procedure of the information processing of the DNN updating according to this embodiment.

The main bodies for the processing in FIG. 6 are the IoT device 200 (the image recognition processing unit 201) for S101 to S103, the conversion server 100 (the DNN conversion unit 101) for S104 to S106, the DNN distribution server 300 (DNN distribution unit 301) for S107, the conversion server 100 (the DNN conversion unit 101) again for S108 and S109, and the IoT device 200 (the image recognition processing unit 201) again for S110.

The series of information processing in FIG. 6 is DNN distribution from the aspect of the cloud side (the conversion server 100) and DNN updating from the aspect of the edge side (the IoT device 200). Note that in the description of this information processing, assumption is made that the number of the IoT devices 200 for requesting updating of a DNN is one.

The series of information processing relating to DNN distribution and DNN updating in FIG. 6 is started by a timer (not shown) set in advance at regular intervals or a trigger from the various sensors 203 provided in the IoT device 200.

The IoT device 200 first checks the situation of the device itself (S101). At this time, the IoT device 200 generates information regarding the state of the device itself and/or the surrounding environment on the basis of the output of the sensor 203, the camera 202, or the like. The state of the device itself may include device information of the device itself such as the type of the CPU 11 and the amount of memory of the ROM 12 and the RAM 13. The surrounding environment may include information that is obtained by inputting output information from the camera 202, the sensor 203, the GPS 205, or the like by a DNN installed in the device itself, and output through feature amount extraction and classification.

Next, the IoT device 200 determines, on the basis of information checked in S101, whether or not the DNN installed in the IoT device 200 needs to be updated (S102). The IoT device 200 determines that the DNN needs to be updated in the case where, for example, the parameter based on the sensing information by the sensor 203 has changed beyond the threshold set in advance, and determines that the DNN does not need to be updated in the case where there is no or little change in the above-mentioned parameter.

In the case where the IoT device 200 determines that the updating is necessary (Yes in S102), the IoT device 200 transmits a request for updating to the conversion server 100 (S103). In the case where the IoT device 200 determines that the updating is not necessary (No in S102), the DNN updating processing ends.

The request for updating transmitted in S103 includes information for specifying one of the DNNs that have been optimized and converted into execution files. The request for updating transmitted in S103 may include information for specifying the specified DNN before being optimized. The conversion server 100 refers to the information and selects the appropriate optimized DNN from the cache 102. In the case where the appropriate optimized DNN is not in the cache 102, optimization and conversion are performed. In addition, the IoT device 200 may transmit information regarding the state of the device itself and/or the surrounding environment to the conversion server 100 as IoT device provision information in S103.

In the conversion server 100 that has received the request for updating from the IoT device 200, the DNN conversion unit 101 checks the cache 102 for whether or not there is a converted DNN file to be updated (S104). In the case where there is no converted file in the cache 102 (No in S104), the DNN conversion unit 101 checks the cache 102 for whether or not there is an original DNN file before being optimized or converted into an execution file (S105).

In the case where there is no original file in the cache 102 (No in S105), the DNN conversion unit 101 requests the DNN distribution server 300 for a new DNN file (S106). In the DNN distribution server 300 that has received the request for a DNN file from the conversion server 100, the DNN distribution unit 302 acquires the requested DNN file from the DNN storage unit 301 and transmits the acquired DNN file to the conversion server 100 (S106).

Next, in the conversion server 100 that has received the DNN file from the DNN distribution server 300, the DNN file received by the DNN conversion unit 101 is optimized in accordance with the performance and state of the IoT device 200 of the distribution target, and is converted into an execution file format (S108).

Next, the DNN conversion unit 101 transmits the optimized and transformed DNN execution file to the IoT device 200 (S109). The IoT device 200 that has received the above-mentioned DNN execution file installs the DNN execution file in the device itself and updates the DNN of the device itself (S110).

In this embodiment, the conversion server 100 located at the upper node of the IoT device 200 optimizes the DNN in accordance with the state of the IoT device 200 and/or the surrounding environment, or prepares the optimized DNN. Since the IoT device 200 receives the DNN and updates the DNN installed in the device itself, the performance of the IoT system can be improved taking into account differences and fluctuations in the performance of the IoT devices. Further, when the DNN is optimized on the basis of the output result of the DNN in S101, the performance of the IoT device 200 can be drawn out more and the performance of the IoT system as a whole can be improved.

[Optimization of Trained Nneural Network]

Hereinafter, the optimization of the DNN will be described with reference to a specific example.

The optimization of the DNN executed by the conversion server 100 in S108 may include optimization by two methods of quantization of parameters and reduction of classifiable types.

Quantization of parameters reduces memory usage and power consumed by computation by decreasing the discreteness of the parameters input to the DNN. For example, in the case where the parameter is represented as a 32-bit float, it is converted into 16-bit floating point or 8-bit fixed point.

The reduction of classifiable types is to reduce classifiable (recognizable) types in the classification/recognition phase shown in FIG. 5. When the reduction of classifiable types is performed, the conversion server 100 increases the number of nodes that is not computed from the final stage of processing by the DNN. This reduces the computational complexity in the classification/recognition phase because the number of nodes that is not computed increases although the number of classifiable types is reduced. As a result, power consumption can also be reduced.

The method of optimizing the DNN by reducing the classifiable types is highly effective when it is performed on the DNN for performing image recognition. This is because the DNN for image recognition often extracts a feature amount in the first half and performs computation for classification in the second half. However, this description is not intended to limit the DNNs handled by the present technology to the image recognition DNN. In accordance with the method of optimizing the DNN by reducing the classifiable types, optimization that reduces the computational complexity can be performed without making significant changes to the DNN.

### Second Embodiment

An embodiment in which the information processing in the IoT device 200 in the above-mentioned embodiment is further concreted is disclosed below.

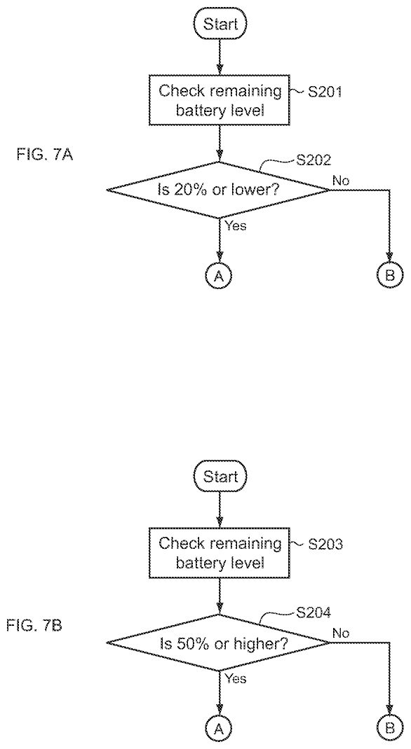

FIG. 7 is a flowchart showing an exemplary procedure of information processing of DNN updating according to this embodiment. In this embodiment, assumption is made that the remaining battery level is checked as an example of the state of the device itself checked by the IoT device 200. The main body for the processing blocks shown in FIG. 7 is the IoT device 200 (or the CPU 11 thereof).

Part (a) of FIG. 7 is shows an example of DNN update flow in which the decrease in the remaining battery level is used as a trigger. Note that the battery 204 is being discharged (driven).

In part (a) of FIG. 7, the IoT device 200 checks the remaining battery level (S201). Specifically, for example, the IoT device 200 activates the remaining battery level checking routine by an interval timer (e.g., 10 second interval) set in advance, and accesses the remaining battery level sensor (one of the sensors 203) to acquire the current remaining battery level.

Next, the IoT device 200 determines whether or not the remaining battery level is equal to or lower than a threshold value (e.g., 20% or lower) (S202). It is connected to A in FIG. 6 when the determination result of S202 is Yes, and it is connected to B when the determination result is No.

After transmitting a request for updating triggered by a low remaining battery level, the IoT device 200 rewrites, in the processing of DNN updating (S110) in FIG. 6, the determination of S202 serving as a reference for determining whether or not to transmit the request for updating the DNN to another condition (e.g., it is determined to be Yes when the remaining battery level is 50% or higher).

Part (b) of FIG. 7 shows an example of the DNN update flow after the above-mentioned rewriting of the condition. In this DNN update flow, the increase in the remaining battery level is a trigger. Note that assumption is made that the battery 204 is being charged (external power source is being driven).

In Part (b) of FIG. 7, the IoT device 200 checks the remaining battery level (S203). Specifically, for example, the IoT device 200 activates the remaining battery level checking routine by an interval timer (e.g., 10 second interval) set in advance, and accesses the remaining battery level sensor (one of the sensors 203) to acquire the current remaining battery level.

Next, the IoT device 200 determines whether or not the remaining battery level has reached a threshold (e.g., 50% or more) (S204). It is connected to A in FIG. 6 when the determination result of S204 is Yes, and it is connected to B when the determination result is No.

Note that in this embodiment, the conversion server 100 transmits, to the IoT device 200 that has transmitted a request for updating by using the increase in the battery remaining level as a trigger, a DNN execution file on which optimization has been executed so that the recognition accuracy is higher and the power consumption is relatively larger than those of the DNN transmitted to the IoT device 200 that has transmitted a request for updating by using the decrease in the remaining battery level as a trigger.

After transmitting a request for updating triggered by the increase in the remaining battery level, the IoT device 200 rewrites, in the processing of DNN updating (S110) in FIG. 6, the determination of S202 serving as a reference for determining whether or not to transmit the request for updating the DNN to another condition (e.g., it is determined to be Yes when the remaining battery level is 20% or lower).

### Third embodiment

In the above-mentioned embodiments, the IoT device 200 compares the parameter based on the state of the device itself and/or the surrounding environment with a certain threshold value to determine the timing when the information processing relating to the DNN updating and the DNN distribution is executed. There are several possible methods to convey the threshold to the IoT device 200, and the present technology is capable of adopting three methods. However, the present technology is not limited to these three.

The first method is a method in which the IoT device 200 periodically communicates with the conversion server 100 or the like to inquire the threshold. In this case, there is an advantage that it is possible to cope with thresholds that change sequentially.

The second method is a method of preparing a table of correspondences between the states of the device and types of optimization that can be applied, and sharing the table between the conversion server 100 and the IoT device 200. This method has an advantage that how much the DNN is optimized by updating the DNN on the IoT device 200 side can be known because how effective it is for each change in the state has been written in the correspondence table.

The third method is a method in which only a threshold value that is optimally available to the currently used DNN is notified to the IoT device and the IoT device autonomously performs DNN updating on the basis of the threshold value. This method has an advantage that the communication traffic is low.

The first and second embodiments were the third method. In this embodiment, information processing of the DNN distribution and the DNN updating by the second method will be described.

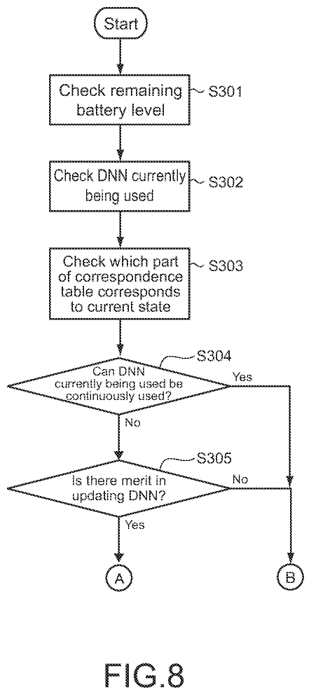

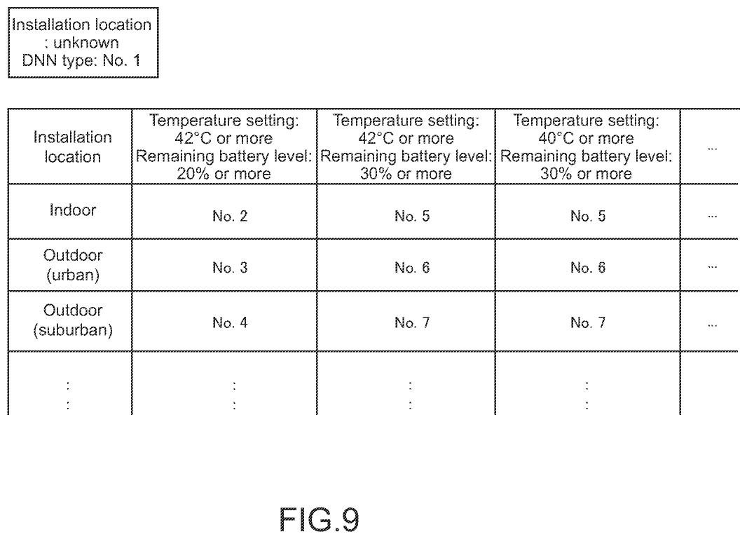

FIG. 8 is a flowchart showing a procedure of information processing for updating the DNN according to this embodiment. The main body of the processing blocks in FIG. 8 is the IoT device 200 (or the CPU 11 thereof). The IoT device 200 stores a correspondence table in which correspondences made between optimized DNNs and the state of the IoT device and/or the surrounding environment are tabulated in the storage unit 18 or the like. FIG. 9 shows an example of the correspondence table.

In FIG. 8, the IoT device 200 first checks the situation of the device itself (S301). This processing is the same as S101 in FIG. 6. Subsequently, the IoT device 200 checks the DNN that the device itself is currently using (S302). Note that in the description of this embodiment, it is assumed that the number of DNNs is one, but the present technology is not limited to this description example. The number of DNNs may be two or more.

Subsequently, the IoT device 200 checks which part of the correspondence table corresponds to the state of the device itself and/or the surrounding environment checked in S301 (S303). In an example of the correspondence table shown in FIG. 9, the “surrounding environment” is set as a row and the “state of the device itself” is set as a column. As an example of the “surrounding environment”, here, the “installation location” is shown. As an example of the “state of the device itself”, here, the combination of the two parameters of the “temperature” and the “remaining battery level” is shown. However, in the case where the installation location is unknown, a predetermined DNN is specified regardless of the “temperature” and the “remaining battery level”.

Note that FIG. 9 shows a part of the correspondence table, and more conditions may be set in the actual correspondence table. Further, successive amounts such as the temperature and the remaining battery level may be set in an overlapping manner, so that switching of optimized DNNs does not occur frequently.

In this embodiment, the “Installation location” is designated in advance from the cloud side, e.g., the conversion server 100. However, this is an example of the specification of the “installation location”, and the present technology is not limited thereto. The “Installation location” may be specified explicitly by a user of the IoT device 200 (on the edge side), or the like. Alternatively, in another Example, the “installation location” may be recognized by a DNN (different from the DNN to be updated) installing the captured image of the camera 202 in the IoT device 200.

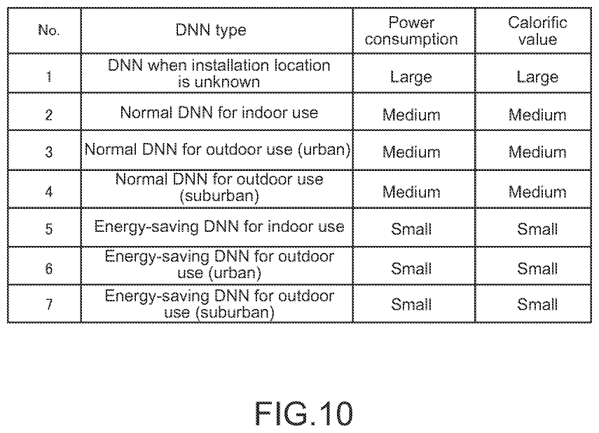

In the correspondence table of FIG. 9, the number of the DNN specified in the cell in which the surrounding environment and the state of the device itself intersect is the number of the DNN optimized for the state of the device itself and the surrounding environment. FIG. 10 illustrates a list of optimized DNNs. The optimized DNNs from No. 1 to No. 7 shown in FIG. 10 are of the following types.

1. DNN when installation location is unknown

2. Normal DNN for indoor use

3. Normal DNN for outdoor use (urban)

4. Normal DNN for outdoor use (suburban)

5. Energy-saving DNN for indoor use

6. Energy-saving DNN for outdoor use (urban)

7. Energy-saving DNN for outdoor use (suburban)

The optimized DNNs of the various types described above have the following assumed power consumption and calorific value, as also shown in FIG. 10.

1. Large

2. Medium

3. Medium

4. Medium

5. Small

6. Small

7. Small

As shown in FIG. 9 and FIG. 10, when the installation location is unknown, the installation location is specified by the high-performance DNN having all the identification capabilities in this embodiment. However, the high-performance DNN consume a large amount of power and generates a lot of heat, so it is inefficient to operate this constantly. For this reason, the high-performance DNN is switched to a DNN in which the power consumption and calorific value are somewhat suppressed while having slightly lower identification capabilities (DNN of No. 4 from DNN of No. 2 in FIG. 10) when the installation location is found. Despite the slight decline in identification capabilities, the performance of the monitoring camera as a whole is hardly degraded because the identification capabilities for objects that should not be displayed at the installation location are reduced.

In addition, in this embodiment, when the remaining battery level is reduced or the temperature becomes higher, the DNN is switched to a DNN (DNN of No. 7 from DNN of No. 5 in FIG. 10) in which power consumption and calorific value are small. As a result, it is possible to avoid battery breakage or failure.

By setting the conditions as shown in FIG. 9 and setting the DNN selected on the basis of them as shown in FIG. 10, a DNN that consumes a small amount of power is selected when the external air temperature is high or the remaining battery level is low, and the operation of the IoT device 200 is optimized. Therefore, the efficiency of the IoT system 1 as a whole is also optimized.

Following S303 in FIG. 8, the IoT device 200 determines whether or not the DNN currently being used can be continuously used on the basis of the result checked in S303 (S304). In the case where it is determined that the DNN currently being used cannot be continuously used (No in S304), the IoT device 200 determines whether or not there is a merit in switching from the DNN currently being used to the DNN recommended by the correspondence table and updating the DNN (S305).

In the case where it is determined in S304 that the DNN can be continuously used (Yes in S304) it is determined in S305 that there is no merit in updating the DNN (No in S305), the flow of information processing is connected to B in FIG. 6. The flow of information processing thereafter is the same as that described with reference to FIG. 6.

Meanwhile, in the case where it is determined that the DNN currently being used cannot be continuously used and there is a merit in updating the DNN (Yes in S305), the flow of information processing is connected to A of FIG. 6. The flow of information processing thereafter is the same as that described with reference to FIG. 6.

In this embodiment, the IoT device 200 may implement a reduction in the performance and/or accuracy of the DNN as a classifier by reducing the number of classifiable items, in other words, by reducing the diversity of classification results.

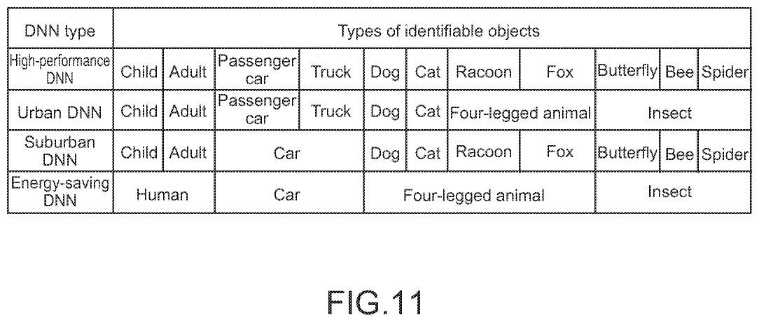

FIG. 11 shows an example of a plurality of DNNs obtained by performing different kinds of optimization on one DNN to achieve different types having different identification capabilities. The DNN in FIG. 11 is a DNN for recognizing the type of the object from a camera image. Note that the DNN type in FIG. 11 is divided into four types, unlike the DNN type divided into seven types in FIG. 10.

While the high-performance DNN is capable of distinguishing an object into 11 types, the energy-saving DNN suppresses the types to only four types, and instead suppresses power consumption and reduces calorific value. However, the DNNs therebetween are not only quantitatively intermediate in identifiable types. The identification accuracy of the DNNs therebetween is lowered in accordance with the installation environments of the IoT devices 200 in which the DNNs operate.

In the urban DNN, animals other than dogs and cats are grouped in the “four-legged animal” because they are unlikely to be displayed in urban areas. The same applies to the “insect”. Further, in the suburban DNN, the types of cars are grouped in “cars” instead of distinguishing them. Further, the energy-saving DNN further reduces power consumption by stopping the distinction between adults and children and integrating dogs and cats into animals. By configuring the DNN in this way, it is possible to realize the optimal power consumption suppression.

### Fourth Embodiment

In the first to third embodiments described above, the IoT device 200 itself determines the necessity of updating the DNN in accordance with the state of the IoT device 200 and/or the surrounding environment (S101 and S102 in FIG. 6, FIG. 7, and FIG. 8), and transmits a request for updating the DNN to the conversion server 100 (S103).

On the other hand, in this embodiment, the conversion server 100 determines the necessity of updating the DNN of the IoT device 200 in accordance with the state of the IoT device 200 and/or the surrounding environment (IoT device provision information) transmitted from the IoT device 200.

The system configuration of this embodiment may be the same as those of the first to third embodiments (FIG. 1 to FIG. 5). The flow of information processing in this embodiment does not differ significantly from that of the first to third embodiment embodiments, but the main body of the processing is the conversion server 100 in this embodiment.

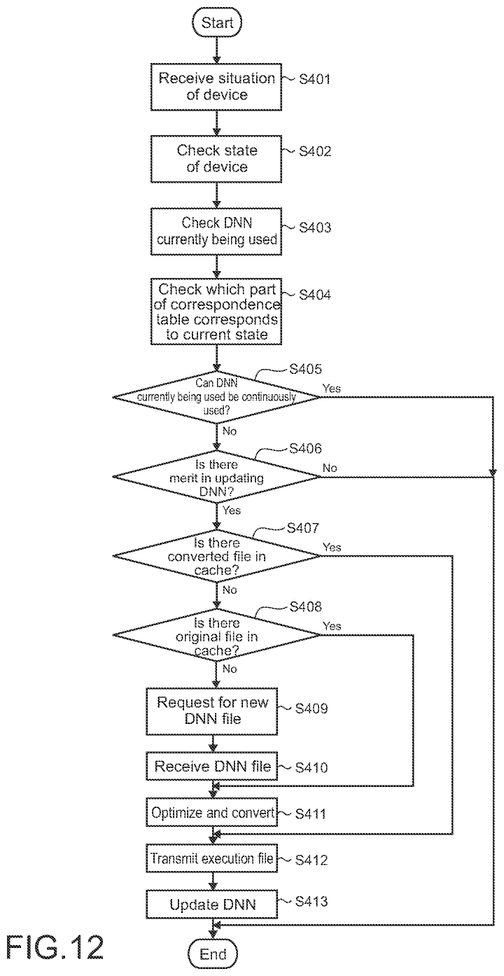

FIG. 12 is a flowchart showing an example of flow of information processing in this embodiment. An example of the information processing shown in FIG. 12 is a modified example of the third embodiment using the correspondence table.

The conversion server 100 receives information regarding the state of the IoT device 200 and/or the surrounding environment (IoT device provision information) from the IoT device 200 (S401). Subsequently, the conversion server 100 checks the received information regarding the state of the IoT device 200 and/or the surrounding environment (IoT device provision information) (S402).

Subsequently, the conversion server 100 checks the DNN that the IoT device 200 is currently using (S403). Here, for example, information of what type of the DNN (DNN before being optimized) is distributed from the DNN distribution server 300 is identified.

Subsequently, the conversion server 100 checks which part of the correspondence table the current state corresponds to (S404). Here, for example, the CPU 11 reads the corresponding table (FIG. 9) corresponding to the type of the DNN checked and identified in S403 from the storage unit 18 or the like. Next, the corresponding DNN (optimized DNN) is known using the information regarding the state of the IoT device 200 and/or the surrounding environment (IoT device provision information) checked in S402 as a parameter.

Subsequently, the conversion server 100 checks whether or not the DNN confirmed to be optimal in the processing of S404 can be continuously used (S405) and whether or not there is a merit in updating the DNN (S406) as in the third embodiment.

In the case where it is determined that the DNN cannot be continuously used and there is a merit in updating the DNN, the conversion server 100 checks whether the cache 102 has a file obtained by converting the DNN confirmed to be optimal in the processing of S404 into an execution file form (S407). In this embodiment, unlike the first to third embodiments, the conversion server 100 does not need to transmit a request for updating to an external device.

In the case where the converted file is not in the cache 102, the conversion server 100 checks whether or not the original file is in in the cache 102 (S408). In the case where the original file is also not in the cache 102, the conversion server 100 requests the DNN distribution server 300 for a new DNN file (S409). When the conversion server 100 receives the new DNN file from the DNN distribution server 300 (S410), the received DNN file is optimized and converted into an execution file format (S411).

Subsequently, the conversion server 100 transmits the DNN that have been optimized and converted into an execution file format to the IoT device 200 that has transmitted the IoT device provision information received in S401 (S412). Subsequently, the conversion server 100 causes the IoT device 200 to update the transmitted DNN. The IoT device 200 applies the received DNN to the device itself, and installs it therein to update the DNN (S413).

In accordance with this embodiment described above, not the IoT device 200 but the conversion server 100 determines whether or not the DNN installed in the IoT device 200 is appropriate for the situation of the IoT device 200 (including the state of the surrounding environment), or which DNN is optimal in the case where the DNN installed in the IoT device 200 is not appropriate for the situation of the IoT device 200. As a result, it is possible to reduce the processing burden on the IoT device 200.

### Other Embodiments

The technology disclosed in the above-mentioned embodiments can be variously modified. For example, although the IoT device 200 itself checks the state of the IoT device 200 and the conversion server 100 is requested for updating the DNN in accordance with the result in the first embodiment or the second embodiment, the conversion server 100 may check the state of the IoT device 200 and determine the necessity of the DNN updating in accordance with the result as in the fourth embodiment.

Further, although the IoT device 200 is a monitoring camera in the above-mentioned embodiments, the IoT device 200 is not limited thereto, and may be, for example, a portable mobile terminal, a smartphone, a notebook personal computer, a portable audio player, a headphone, or an earphone.

Note that the information processing disclosed above can be provided by a software program. As the form of providing such a program, the program may be provided by a recording medium regardless of magnetically or optically, or may be provided by being downloaded through a telecommunication line.

[Appendix]

The present technology may also take the following configurations.

(1) An information processing apparatus, including:

a communication unit capable of communicating with an IoT (Internet of Things) device; and

a control unit that optimizes a trained neural network on the basis of IoT device provision information regarding a state of the IoT device or a surrounding environment, the IoT device provision information being received from the IoT device, and transmits an execution file of the trained neural network after the optimization to the IoT device.

(2) The information processing apparatus according to (1) above, in which

the control unit selects, on the basis of a correspondence between the IoT device provision information and a plurality of trained neural networks after the optimization, the trained neural network corresponding to the IoT device provision information received from the IoT device.

(3) The information processing apparatus according to (1) or (2) above, in which

the IoT device provision information includes information based on an output obtained by inputting the state of the IoT device and/or the surrounding environment into the trained neural network installed in the IoT device, and

the control unit selects one of the plurality of trained neural networks after the optimization on the basis of the information based on the output.

(4) The information processing apparatus according to any one of (1) to (3) above, in which

the IoT device provision information includes information specifying one of the plurality of trained neural networks after the optimization, and

the communication unit transmits the specified trained neural network after the optimization.

(5) The information processing apparatus according to any one of (1) to (4) above, further including

a cache that stores the trained neural network optimized by the control unit, in which

the communication unit transmits, where the same trained neural network after the optimization corresponding to pieces of IoT device provision information received from the plurality of different IoT devices is stored in the cache, the same trained neural network after the optimization stored in the cache to the plurality of different IoT devices.

(6) The information processing apparatus according to any one of (1) to (5) above, in which

the control unit optimizes the trained neural network by reducing performance and/or accuracy of the trained neural network as a classifier.

(7) The information processing apparatus according to (6) above, in which

the trained neural network extracts a feature amount from input information regarding the state of the IoT device and/or the surrounding environment, and classifies the input information into a plurality of types on the basis of the extracted feature amount, and

the control unit reduces the number of the plurality of types classified by the trained neural network, thereby reducing performance and/or accuracy of the classifier.

(8) An information processing method, including:

optimizing a trained neural network on the basis of information regarding a state of an IoT (Internet of Things) device and/or a surrounding environment, the information being received from the IoT device; and

transmitting the optimized trained neural network to the IoT device.

(9) A program that causes a computer to execute the steps of:

optimizing a trained neural network on the basis of information regarding a state of an IoT (Internet of Things) device and/or a surrounding environment, the information being received from the IoT device; and

transmitting the optimized trained neural network to the IoT device.

(10) An IoT device in which a trained neural network is installed, including:

a communication unit capable of communicating with an information processing apparatus; and

a control unit that

selects a trained neural network corresponding to a state of the IoT device and/or a surrounding environment,

transmits a request signal to the information processing apparatus, the request signal requesting optimization of the selected trained neural network and transmission of an execution file of the neural network after the optimization, and updates the installed trained neural network using the received execution file of the trained neural network after the optimization.

### REFERENCE SIGNS LIST

1 IoT system

100 conversion server

101 DNN conversion unit

102 cache

200 IoT device

201 image recognition processing unit

202 camera

203 sensor

300 DNN distribution server

1. An information processing apparatus, comprising:
a communication unit capable of communicating with an IoT (Internet of Things) device; and
a control unit that optimizes a trained neural network on a basis of IoT device provision information regarding a state of the IoT device or a surrounding environment, the IoT device provision information being received from the IoT device, and transmits an execution file of the trained neural network after the optimization to the IoT device.

2. The information processing apparatus according to claim 1, wherein
the control unit selects, on a basis of a correspondence between the IoT device provision information and a plurality of trained neural networks after the optimization, the trained neural network corresponding to the IoT device provision information received from the IoT device.

3. The information processing apparatus according to claim 1, wherein
the IoT device provision information includes information based on an output obtained by inputting the state of the IoT device and/or the surrounding environment into the trained neural network installed in the IoT device, and
the control unit selects one of the plurality of trained neural networks after the optimization on a basis of the information based on the output.

4. The information processing apparatus according to claim 1, wherein
the IoT device provision information includes information specifying one of the plurality of trained neural networks after the optimization, and
the communication unit transmits the specified trained neural network after the optimization.

5. The information processing apparatus according to claim 1, further comprising
a cache that stores the trained neural network optimized by the control unit, wherein
the communication unit transmits, where the same trained neural network after the optimization corresponding to pieces of IoT device provision information received from the plurality of different IoT devices is stored in the cache, the same trained neural network after the optimization stored in the cache to the plurality of different IoT devices.

6. The information processing apparatus according to claim 1, wherein
the control unit optimizes the trained neural network by reducing performance and/or accuracy of the trained neural network as a classifier.

7. The information processing apparatus according to claim 6, wherein
the trained neural network extracts a feature amount from input information regarding the state of the IoT device and/or the surrounding environment, and classifies the input information into a plurality of types on a basis of the extracted feature amount, and
the control unit reduces the number of the plurality of types classified by the trained neural network, thereby reducing performance and/or accuracy of the classifier.

8. An information processing method, comprising:
optimizing a trained neural network on a basis of information regarding a state of an IoT (Internet of Things) device and/or a surrounding environment, the information being received from the IoT device; and
transmitting the optimized trained neural network to the IoT device.

9. A program that causes a computer to execute the steps of:
optimizing a trained neural network on the basis of information regarding a state of an IoT (Internet of Things) device and/or a surrounding environment, the information being received from the IoT device; and
transmitting the optimized trained neural network to the IoT device.

10. An IoT device in which a trained neural network is installed, comprising:
a communication unit capable of communicating with an information processing apparatus; and
a control unit that
selects a trained neural network corresponding to a state of the IoT device and/or a surrounding environment,
transmits a request signal to the information processing apparatus, the request signal requesting optimization of the selected trained neural network and transmission of an execution file of the neural network after the optimization, and
updates the installed trained neural network using the received execution file of the trained neural network after the optimization.
